(19) United States
(12) Patent Application Publication
(10) Pub. No.: US 2012/0060878 A1
(43) Pub. Date: Mar. 15, 2012

(54) CANE WITH REMOTELY-OPERATED JAW

(75) Inventor: Jay Thiessens, Sparks, NV (US)

(73) Assignee: GRAPPLERS, INC., Sparks, NV (US)

(21) Appl. No.: 12/879,894

(22) Filed: Sep. 10, 2010

(51) Int. Cl. A45B 3/00; B25J 1/04

(52) U.S. Cl. 135/66; 294/104

(57) ABSTRACT

A cane includes a remotely-operated jaw. The jaw is defined by a single moving element, mounted to pivot about a point which is spaced apart from the lower portion of the shaft of the cane. A rod, connected at one end to a trigger, and connected at another end to the moving element, causes the element to pivot when the trigger is pulled, and thus causes the jaw to close. A locking pin, located near the trigger, locks the rod in place, so that the product can be used as an ordinary cane. The rod, the jaw, and the trigger are permanently held outside of the body of the cane, so that the structural integrity of the cane is not compromised.

### BACKGROUND OF THE INVENTION

The present invention relates to the field of assisting elderly or infirm persons, by providing a cane which enables a user to pick up objects without having to bend over.

Elderly or infirm persons, having need of a cane for assistance in walking, often have difficulty bending over to retrieve items from the ground. For example, such a person might drive to a store, park his car, and then accidentally drop his car keys. Retrieval of the keys may be difficult or impossible, depending on the person's medical condition. Unless there are others nearby who are available to help, the person may have no way of retrieving the keys.

It has been known to combine a cane with a gripping mechanism, or the like, to allow an elderly or infirm user to solve the problem posed above. The user then needs to carry only one aid, which functions both as a cane, and as a device which assists in retrieving fallen objects.

Examples of prior patents and patent applications, which disclose canes having gripping devices, are described below.

U.S. Pat. No. 3,093,402 discloses a combination cane and retriever. The user presses a button 17 on the handle, which causes a pair of jaws to open and close, enabling an infirm person to pick up an object more easily.

U.S. Pat. No. 3,467,116 discloses a walking stick having fingers disposed at the distal end of the stick, the fingers being controllable to pick up objects.

U.S. Pat. No. 3,763,872 discloses another cane having fingers for grasping an object.

U.S. Pat. No. 4,811,750 discloses a cane which includes fingers for gripping objects, the fingers being extendable from the cane.

U.S. Pat. No. 5,176,160 discloses a cane having a jaw portion at the distal end. A trigger near the handle operates the jaw.

U.S. Pat. No. 5,433,234 discloses a cane having a grasping mechanism at the lower end, the grasping mechanism being operated by a lever near the handle.

U.S. Pat. No. 5,636,650 discloses a telescoping cane which also includes means for picking up objects, such as keys.

U.S. Pat. No. 5,640,985 discloses an adjustable length cane having a grasping apparatus, the grasping apparatus being operated by a trigger located near the handle.

U.S. Pat. No. 5,795,004 discloses an extendable device for grasping an object on the floor.

U.S. Pat. No. 6,058,953 discloses a walking aid with a retractable pick-up device.

U.S. Pat. No. 6,386,216 discloses an extendable cane which also includes a grasping device.

U.S. Patent Application Publication No. 2004/0040588 discloses a cane with a gripping device, the gripping device being operated by a control near the handle.

All of the above-cited patents, and the cited patent application, are hereby incorporated by reference into this disclosure.

The present invention provides a cane with a remotely-operated jaw, the device of the present invention representing a substantial improvement over the devices of the prior art. The present invention provides a simple and reliable jaw mechanism, while preserving the structural integrity of the cane. The device of the present invention can also be manufactured relatively inexpensively.

### SUMMARY OF THE INVENTION

The cane of the present invention comprises a cane body which includes a handle portion and a substantially straight shaft. Near the bottom of the cane is a jaw comprising a single moving element which is pivotably mounted to a clamp which is affixed to the lower end of the shaft. A straight and rigid rod is engaged with the moving element such that longitudinal movement of the rod causes the moving element to pivot, and thereby causes the jaw to close against the shaft. Thus, items can be grasped between the moving element and the shaft. A trigger, located near the handle portion, is connected to the rod, so that pulling on the trigger causes the rod to move longitudinally, and thereby causes the jaw to close. The rod, the jaw, and the trigger are all permanently held outside the body of the cane.

In the preferred embodiment, the lower end of the rod comprises a hook which engages a pin connected to the moving jaw element. In another embodiment, the lower end of the rod is inserted within a block which is connected to the moving element.

The handle portion of the cane includes a grip which is generally perpendicular to the shaft. The trigger includes a proximal finger which is generally parallel to the grip. A locking pin provides means for locking the rod in a selected longitudinal position.

The present invention therefore has the primary object of providing a cane which has a remotely-operated jaw.

The invention has the further object of enabling elderly or infirm persons to pick up objects from the floor or ground, without having to bend over.

The invention has the further object of providing a cane as described above, wherein the strength of the cane is not substantially compromised by the addition of a remotely-operated jaw.

The invention has the further object of providing a cane as described above, wherein the cane can be manufactured reasonably inexpensively, while providing the desired utility.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a perspective view of the cane of the present invention.

FIG. 1A provides a fragmentary perspective view of an alternative embodiment, in which a rod engages a jaw by means of a hook at the lower end of the rod.

FIG. 2 provides a perspective view, showing the use of the cane of the present invention in retrieving an object, the figure showing the trigger being pulled so as to operate the jaw attached to the cane.

FIG. 3 provides a perspective view, similar to that of FIG. 2, wherein the trigger has been pulled to the maximum extent, and wherein the object is gripped by the jaw.

FIG. 4 provides a fragmentary elevational view, illustrating the bottom portion of the cane of the present invention, and especially showing the jaw.

FIG. 5 provides a view similar to that of FIG. 4, but in which a plate has been removed to illustrate the internal components of the jaw.

FIG. 6 provides a fragmentary elevational view, illustrating the top portion of the present invention, showing the handle and trigger in a position where the jaw has not yet been fully actuated.

FIG. 7 provides a view similar to that of FIG. 6, in which the trigger has been pulled to its maximum proximal position.

### DETAILED DESCRIPTION OF THE INVENTION

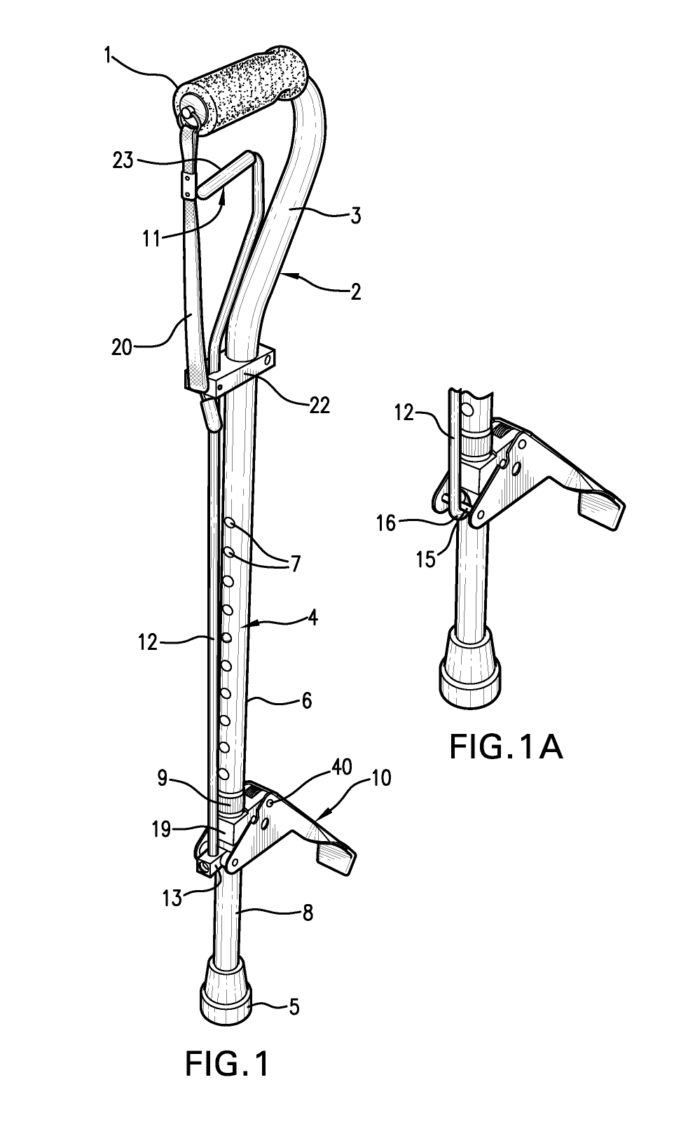

FIG. 1 illustrates the cane of the present invention, in a perspective view. The cane includes a handle portion which comprises grip 1 and angled portion 3. The angled portion is connected to a substantially straight shaft 4. The handle portion and the shaft together comprise body 2 of the cane. The grip 1 is generally perpendicular to the shaft. Thus, when the shaft of the cane is in its upright position, and held perpendicular to the ground, the grip is generally parallel to the ground.

The shaft 4 is formed of two telescoping sections, an upper section 6 having a plurality of holes 7, and a lower section 8 which telescopes from the upper section. The two sections are fastened together, and held in a selected position, by nut 9. The lower section 8 terminates in a protector 5, which could be plastic or rubber or the like.

A jaw 10 is mounted near the lower portion of the cane. The jaw comprises a single moving element; gripping by the jaw is accomplished by pivoting the jaw against the shaft of the cane. The jaw is connected to the shaft by a first clamp 19, located near the lower end of the shaft. The clamp 19 engages the shaft, and also defines pin 40 about which the moving element can pivot. The jaw is spring-biased such that it is normally open.

A trigger 11 is connected to a rod 12. The lower end of the rod is seated in a block 13 which is connected to the jaw. The rod is generally straight and rigid, and is preferably made of metal. Upward longitudinal movement of the rod, caused by the pulling of the trigger, pulls on pin 15 (the pin being more clearly shown in FIG. 1A), and this pulling motion causes the jaw to pivot to a closed position.

In the embodiment of FIG. 1A, there is no block. Instead, the rod terminates in a hook 16 which engages the pin 15. Pulling on the pin 15 causes the pin to translate, and this translational motion causes the moving element to rotate.

The embodiment of FIG. 1A is considered preferable, because it is less expensive to manufacture. But either embodiment could be used in the present invention. With respect to all figures showing a block, it should be understood that the hook and pin structure of FIG. 1A could be substituted.

The rod 12 is held, in the vicinity of its upper end, by a second clamp 22, which is affixed to shaft 4. When the trigger is pulled, the rod moves longitudinally through a hole in clamp 22.

A strap 20 attached to handle 1 enables the cane to be hung, or otherwise carried or stored, when not in use.

The rod 12, the moving element 10, and the trigger 11 are permanently held outside of the body of the cane. That is, none of these elements is disposed inside the shaft or the handle portion.

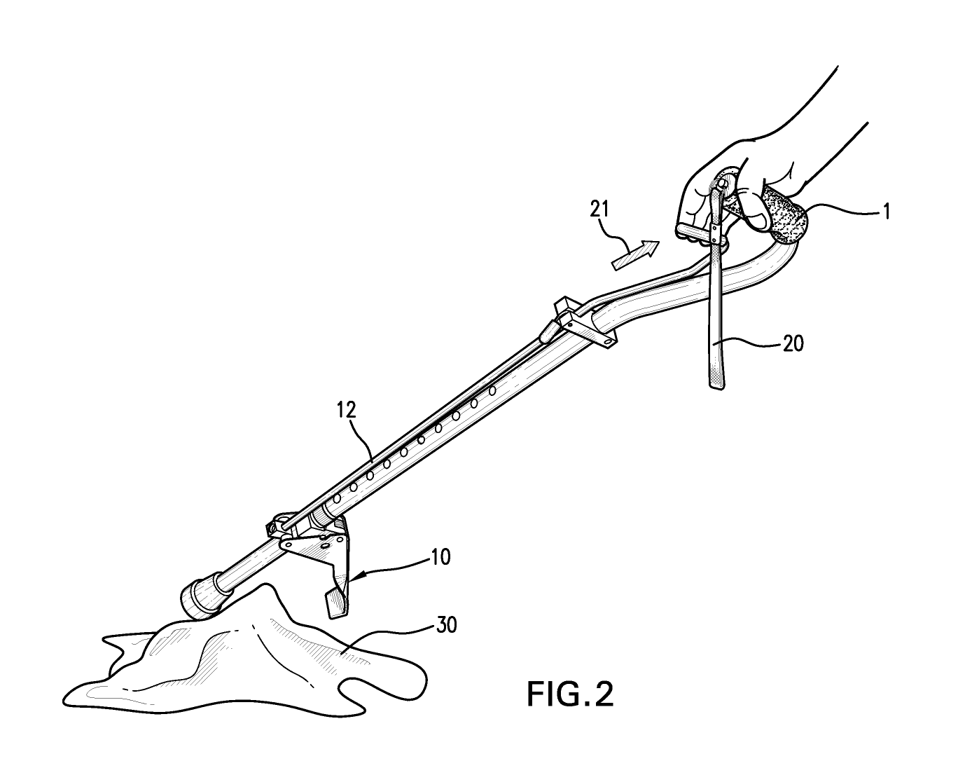

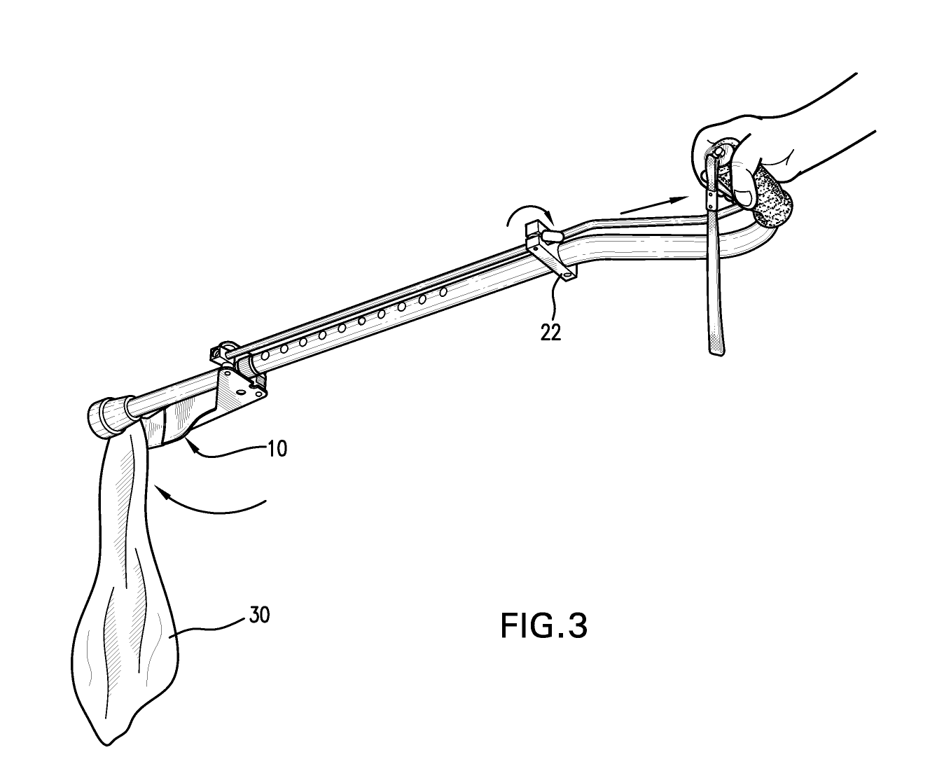

FIGS. 2 and 3 illustrate the use of the cane of the present invention in retrieving an article from the floor or ground. In the figures, the article to be retrieved is kerchief 30. As shown in FIG. 2, to retrieve the article, one positions the cane such that the jaw is in the vicinity of the article. Then the trigger is pulled, as indicated by arrow 21. Pulling on the trigger causes rod 12 to move longitudinally, in the direction of handle 1, thereby causing the jaw 10 to move. In FIG. 3, the jaw 10 has reached its fully closed position, and the article is thereby caught between the jaw and the lower section 8 of the shaft, or between the jaw and the protector 5.

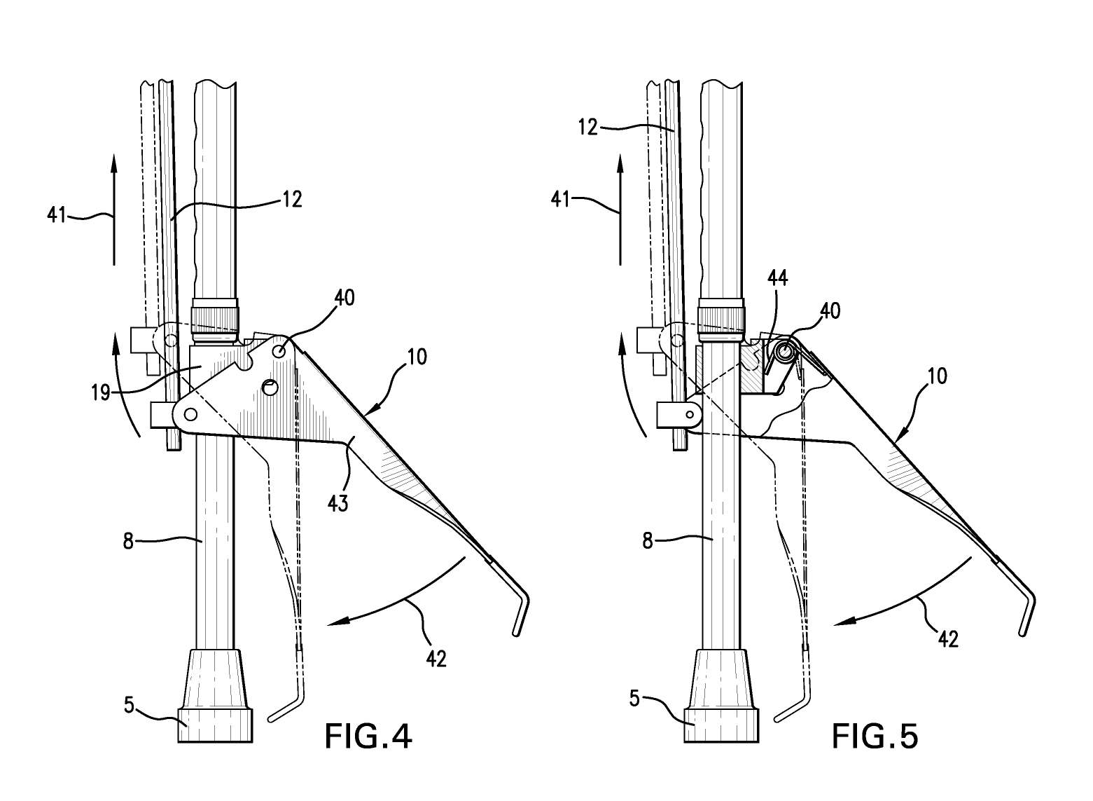

FIGS. 4 and 5 illustrate more details of the jaw assembly. In both figures, the jaw 10 is shown in its open position, in full, and in its closed position, in phantom. As explained above, the jaw is attached to a first clamp 19 which is tightly mounted to the shaft. The point of attachment of the moving element to the clamp is at pin 40, which is spaced apart from the shaft. Thus, the moving element of the jaw is mounted to pivot about pin 40, i.e. about a point which is displaced from the shaft.

The rod 12 is engaged with the moving element of the jaw on the opposite side of the shaft, relative to the pivot point. Thus, when the rod is pulled upward, as indicated by arrow 41, the jaw pivots in a clockwise direction, as shown by arrow 42, and reaches the closed position shown by the phantom drawing.

In FIG. 4, there is a cover plate 43 which obscures some of the components of the jaw. In FIG. 5, this plate is has been removed. FIG. 5 illustrates spring 44, which biases the jaw in its open position.

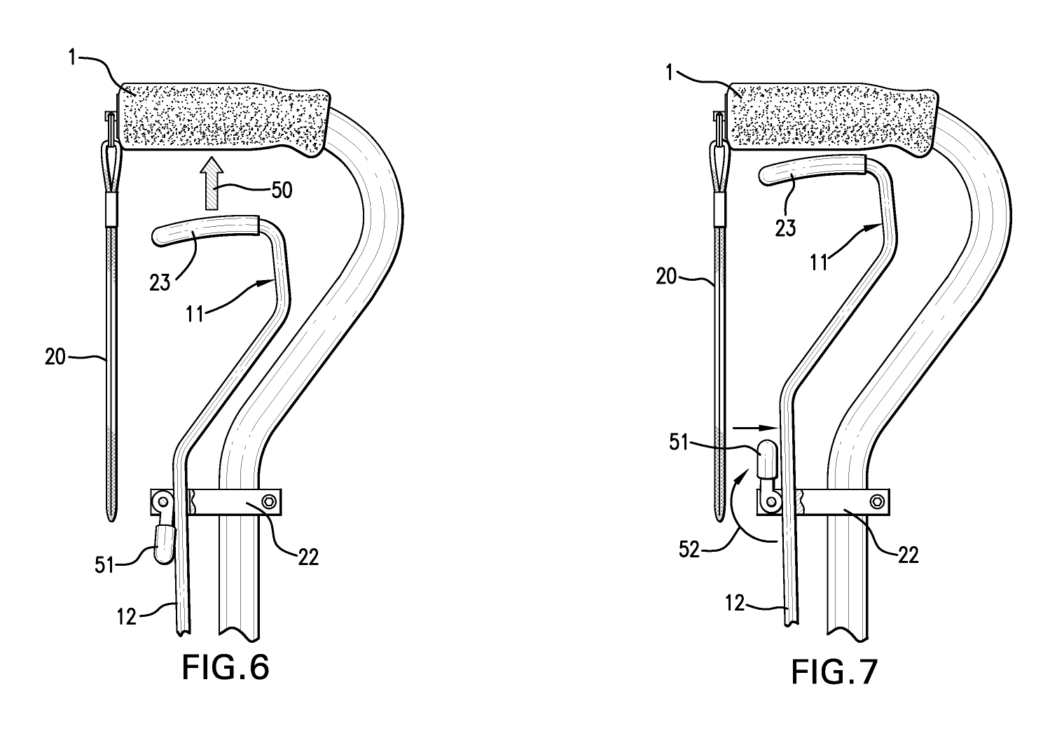

FIGS. 6 and 7 illustrate the top portion of the cane of the present invention, in two different conditions. The trigger 11 includes a proximal finger 23 which is generally parallel to grip 1 of the handle portion. In FIG. 6, the trigger 11 is being pulled in the direction indicated by arrow 50. In FIG. 7, the trigger has been pulled to its maximum extent. Locking pin 51 enables the user to hold the jaw in a selected position, by preventing further longitudinal movement of the rod 12. In FIG. 6, the locking pin is in the open position, allowing the rod 12 to move freely as the trigger is pulled. In FIG. 7, the locking pin has been rotated, as indicated by arrow 52, so as to lock the rod in a selected longitudinal position.

One important feature of the cane of the present invention is that the cane has no elongated slots. In many prior art devices, the jaw mechanism is stored within the body of the cane, and it is necessary to provide relatively large slots or openings to allow the components to exit. The absence of such slots or large openings maintains the integrity of the body of the cane. The holes 7, used for adjusting the length of the cane, are small, and do not appreciably affect the strength of the cane. In the preferred embodiment, the shaft is hollow and its interior is empty. Unlike many devices of the prior art, the interior of the shaft of the cane is not used to house or store any components of the invention. It is even possible for the interior of the shaft to be filled with material, but this alternative is considered less desirable because it increases the expense and weight of the cane.

In the preferred embodiment, the length of the cane is set in the factory, and the components of the shaft are tightly joined. Thus, for practical purposes, the user can treat the shaft as if it were made of one piece. The cane of the present invention is therefore intended to be customized to the height of the intended user. However, it is also possible to provide a cane having a length which is adjustable by the user.

Another important feature of the present invention is the use of a single jaw. The movable jaw interacts with the bottom portion of the cane itself, to establish a means for gripping objects. In the present invention, there is only a single moving jaw element.

Another important feature of the present invention is the positioning of the trigger near the handle of the cane. Thus, the user can firmly grip the handle, while still being able to engage the trigger, as shown in FIGS. 2 and 3.

In the present invention, the components which enable operation of the jaw, including the trigger and rod, are permanently clamped onto the cane body, and are not intended to be removed from the cane by the user. As noted above, the jaw of the cane can be locked, by locking pin 51, in a desired position. If the user wishes to use the cane without using the jaw, the jaw can be locked in its closed position, and the cane will function essentially as an ordinary cane.

The invention can be modified in various ways. As noted above, the manner of connection of the rod to the jaw can be varied. The shape of the jaw can be changed. These and other modifications, which will be apparent to the reader skilled in the art, should be considered to be within the spirit and scope of the following claims.

What is claimed is:

1. A cane having a remotely-operated jaw, comprising:
a) a cane body including a handle portion and a substantially straight shaft,
b) a jaw comprising a single moving element, the element being pivotably mounted, in a vicinity of a lower end of the shaft, by a first clamp which connects the moving element to the shaft,
c) a trigger, connected to a substantially straight and rigid rod, the rod having upper and lower ends, the rod being held, in a vicinity of its upper end, by a second clamp which is affixed to the shaft in a vicinity of the upper end of the rod, the rod being engaged, in a vicinity of its lower end, with the moving element such that longitudinal movement of the rod, caused by pulling of the trigger, causes the moving element to pivot,
wherein the rod, the jaw, and the trigger are permanently held outside of the body of the cane.

2. The cane of claim 1, wherein the rod is inserted within a block which is connected to the moving element.

3. The cane of claim 1, wherein the lower end of the rod comprises a hook which is engaged with a pin connected to the moving element, wherein translational movement of the pin causes the moving element to pivot.

4. The cane of claim 1, wherein the handle portion includes a grip which is generally perpendicular to the shaft, and wherein the trigger includes a proximal finger which is generally parallel to the grip.

5. The cane of claim 1, wherein the first clamp extends from the shaft to define a pivot point for the moving element, the pivot point being spaced apart from the shaft, and wherein the rod is engaged with the moving element on an opposite side of the shaft relative to said pivot point.

6. The cane of claim 1, further comprising a locking pin connected to said second clamp, the locking pin comprising means for locking the rod in a selected longitudinal position.

7. The cane of claim 1, wherein the first clamp is connected to a spring which biases the moving element in an open position.

8. A cane having a remotely-operated jaw, comprising:
a) a cane body including a handle portion and a substantially straight shaft,
b) a jaw comprising a single moving element, the element being pivotably mounted, in a vicinity of a lower end of the shaft, by a first clamp which connects the moving element to the shaft,
c) a trigger, connected to a substantially straight and rigid rod, the rod having upper and lower ends, the rod being held, in a vicinity of its upper end, by a second clamp which is affixed to the shaft in a vicinity of the upper end of the rod, the rod being engaged, in a vicinity of its lower end, with the moving element such that longitudinal movement of the rod, caused by pulling of the trigger, causes the moving element to pivot,
wherein the rod, the jaw, and the trigger are permanently held outside of the body of the cane,
wherein the lower end of the rod comprises a hook which is engaged with a pin connected to the moving element, wherein translational movement of the pin causes the moving element to pivot, and
wherein the first clamp extends from the shaft to define a pivot point for the moving element, the pivot point being spaced apart from the shaft, and wherein the rod is engaged with the moving element on an opposite side of the shaft relative to said pivot point.

9. The cane of claim 8, wherein the handle portion includes a grip which is generally perpendicular to the shaft, and wherein the trigger includes a proximal finger which is generally parallel to the grip.

10. The cane of claim 9, further comprising a locking pin connected to said second clamp, the locking pin comprising means for locking the rod in a selected longitudinal position.

11. The cane of claim 8, wherein the first clamp is connected to a spring which biases the moving element in an open position.

12. A cane having a remotely-operated jaw, comprising:
a) a cane body including a handle portion and a substantially straight shaft,
b) a jaw comprising a single moving element, the element being pivotably mounted, in a vicinity of a lower end of the shaft, by a first clamp which connects the moving element to the shaft,
c) a trigger, connected to a substantially straight and rigid rod, the rod having upper and lower ends, the rod being held, in a vicinity of its upper end, by a second clamp which is affixed to the shaft in a vicinity of the upper end of the rod, the rod being engaged, in a vicinity of its lower end, with the moving element such that longitudinal movement of the rod, caused by pulling of the trigger, causes the moving element to pivot,
wherein the rod, the jaw, and the trigger are permanently held outside of the body of the cane,
wherein the handle portion includes a grip which is generally perpendicular to the shaft, and wherein the trigger includes a proximal finger which is generally parallel to the grip, and
wherein the first clamp extends from the shaft to define a pivot point for the moving element, the pivot point being spaced apart from the shaft, and wherein the rod is engaged with the moving element on an opposite side of the shaft relative to said pivot point.

13. The cane of claim 12, further comprising a locking pin connected to said second clamp, the locking pin comprising means for locking the rod in a selected longitudinal position.

14. The cane of claim 12, wherein the first clamp is connected to a spring which biases the moving element in an open position.
